(19) United States
(12) Patent Application Publication
(10) Pub. No.: US 2011/0101289 A1
(43) Pub. Date: May 5, 2011

(54) FLOOR TILE PUSHER

(75) Inventor: Wei-Sheng Lee, Changhua County (TW)

(73) Assignee: ROMP ENTERPRISE CO., LTD., Taichung (TW)

(21) Appl. No.: 12/649,219

(22) Filed: Dec. 29, 2009

(30) Foreign Application Priority Data
Nov. 3, 2009 (TW) 98220325

(51) Int. Cl. B66F 19/00; E04F 21/18

(52) U.S. Cl. 254/103; 52/749.11

(57) ABSTRACT

A floor tile pusher includes a base, on which a bar is provided for reciprocation and a driving gear is provided for rotation. The bar and the driving gear have teeth to be meshed with each other. An exerting member is connected to an end of the bar, and a handle is connected to the driving member for turning. User may turn the handle to move the exerting member toward or backward. The base has an end bent downward to form a reverse exerting portion, and a support member is provided on the base to be moved between an extended position and a folded position. When the support member is moved to the extended position, a distal end of the support member is even to a distal end of the reverse exerting portion.

### BACKGROUND OF THE INVENTION

1. Field of the Invention

The present invention relates generally to a DIY tool, and more particularly to an assisting device in tiling floor which may help to press floor tiles and make them tightly tiled together.

2. Description of the Related Art

In U.S. Pat. No. 7,451,671, Coleman discloses a device, which is applied in tiling DIY floor tiles to press them tightly tiled together, having a base plate, a rank with a ram pusher at an end thereof, a driving gear meshed with the rank, and a bar for manipulation. Worker may turn the bar to drive the rank forward that the ram pusher may urge a floor tile to tightly engage with the neighboring floor tile.

For floor tiles close to wall without sufficient space for the device, Coleman further teaches a resolution by mounting a removable shoe (member?) on the base plate. In this case the base plate is put on the floor tile with the shoe engaged with it, and user operates the bar to drive the ram pusher urging the wall such that the base plate is forced to move backward and the shoe may draw the floor tile to the neighboring one.

Coleman teaches about a removable shoe for this device because this device works for two of aforesaid working modes. It is obvious that to mount and detach the shoe will slow down the work, and there is a risk of losing the shoe when it is detached. Furthermore, under some working conditions, it takes huge output power to urge the floor tile (the maximum output power is one ton as a common designation). The removable shoe cannot take such huge output power before breaking down.

### SUMMARY OF THE INVENTION

The primary objective of the present invention is to provide a floor tile pusher capable of providing greater output power.

The secondary objective of the present invention is to provide a floor tile pusher, which has an easier way to lock and release.

According to the objectives of the present invention, a floor tile pusher includes a base, on which a bar is provided for reciprocation and a driving gear is provided for rotation. The bar and the driving gear have teeth to be meshed with each other. An exerting member is connected to an end of the bar, and a handle is connected to the driving member for turning. User may turn the handle to move the exerting member toward or backward. The base has an end bent downward to form a reverse exerting portion, and a support member is provided on the base to be moved between an extended position and a folded position. When the support member is moved to the extended position, a distal end of the support member is even to a distal end of the reverse exerting portion.

### BRIEF DESCRIPTION OF THE DRAWINGS

FIG. 1 is an exploded view of a preferred embodiment of the present invention;

FIG. 2 is a perspective view of the preferred embodiment of the present invention, showing the support member at the extended position;

FIG. 3 is a perspective view of the preferred embodiment of the present invention, showing the support member at the folded position;

FIG. 4 is a sectional view of the preferred embodiment of the present invention, showing the paws engaged with the driving gear in the normal condition;

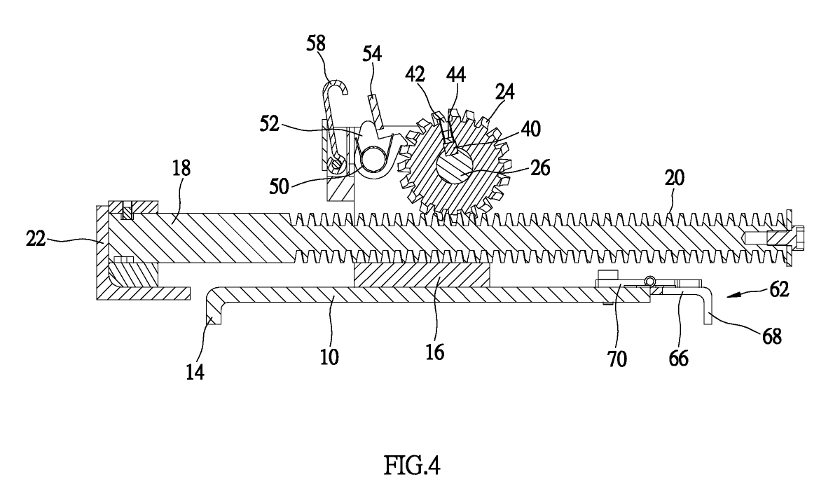

FIG. 5 is a sectional view of the preferred embodiment of the present invention, showing the paws disengaged with the driving gear when user exerts the release member and uses the hook hooking the release member;

FIG. 6 is a sketch diagram of the preferred embodiment of the present invention, showing the floor tile pusher being operated to have the exerting member pressing the floor tile; and

FIG. 7 is a sketch diagram of the preferred embodiment of the present invention, showing the tile pusher being operated to have the reverse exerting member pressing the floor tile.

### DETAILED DESCRIPTION OF THE INVENTION

Please refer to the drawings, a floor tile pusher of the preferred embodiment of the present invention includes:

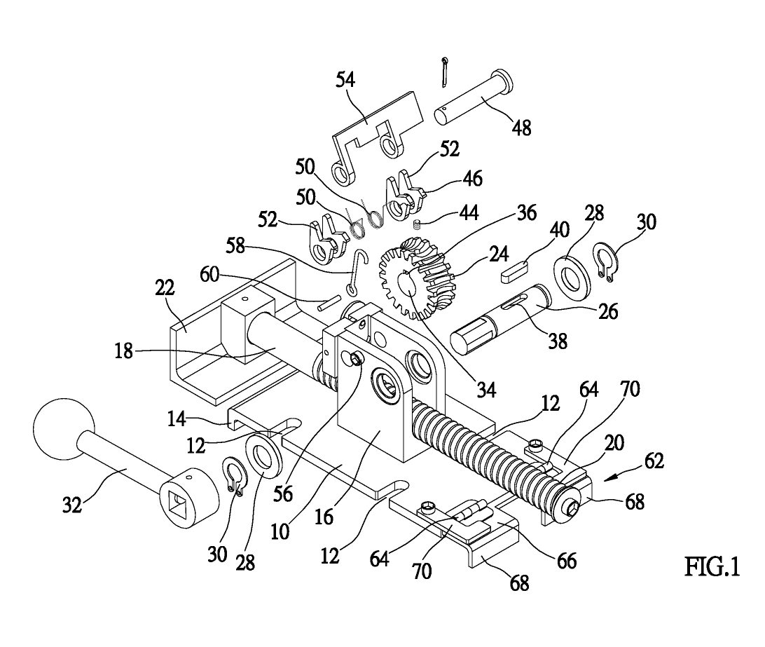

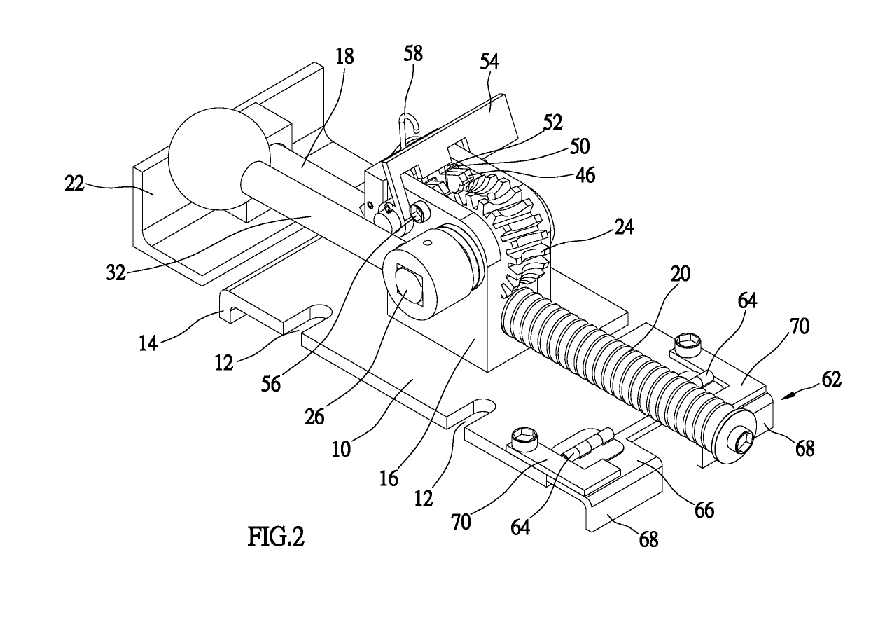

As shown in FIG. 1 and FIG. 2, a base 10, which is a rectangular board, has four recesses 12 at opposite sides. Bolts or screws (not shown) may be inserted into the recesses 12 respectively to fix the base 10 at a predetermined place. The base 10 has a downward-bended front end to form a reverse exerting portion 14 and a frame 16 on a top side thereof.

A bar 18 is movably mounted on the frame 16 for reciprocation. The bar is provided with teeth 20 and an exerting member 22 at a front end thereof.

A driving gear 24 is pivoted on the frame 16 and is meshed with the teeth 20 of the bar 18. A shaft 26 passes through the frame 16 and the driving gear 24, and then is fixed by washers 28 and C-rings 30. An end of the shaft 26 is connected to a handle 32 that user may turn the handle 32 to rotate the driving gear 24, and then the bar 18 may be moved forward and backward. The driving gear 24 has a bore 34 at a center thereof and a slot 36 on a sidewall of the bore 34. The shaft 26 has a slot 38 also. A block 40 is put in the slots 36, 38 of the driving gear 24 and the shaft 26 to firmly connect them together. The driving gear 24 has a radial threaded bore 42 extending to the slot 36. A threaded pin 44 is screwed into the threaded bore 42 of the driving gear 24 to press the block 40 that may ensure the connection of the shaft 26 and the driving gear 24.

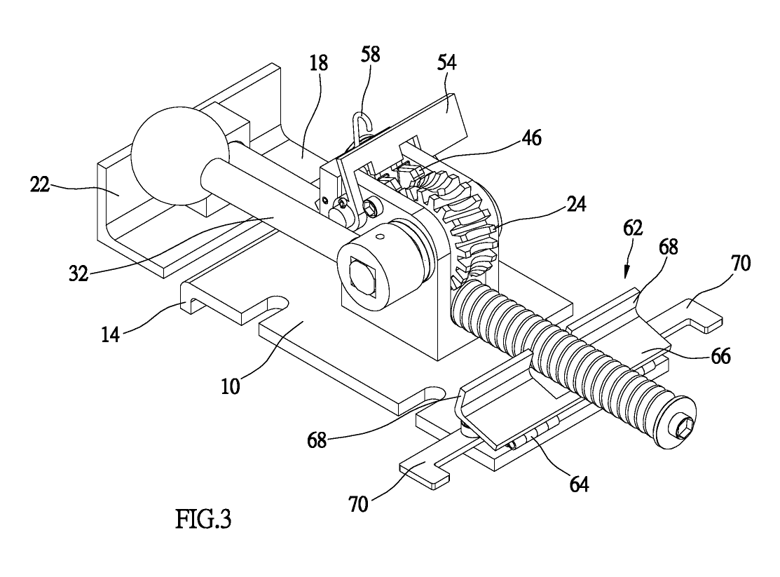

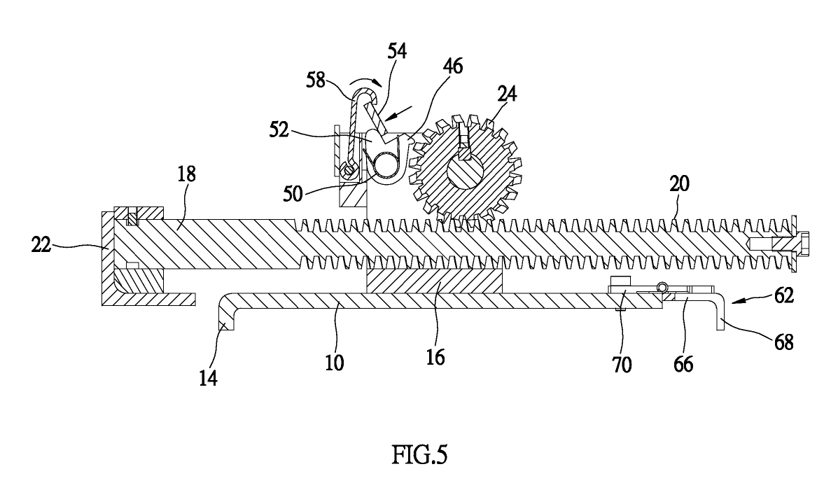

Two paws 46 are pivoted on the frame 16 by a shaft 48. Two torsional springs 50 are fitted to the shaft 48 to urge the paws 46 toward the driving gear 24 that the paws 46 are normally meshed with the driving gear 24 (FIG. 3). Each paw 46 has a lever 52 at a rear. A release member 54, which is a plate, has an end pivoted on the frame 16 and crosses over the frame 16 that the release member 54 touches the levers 52 of the paws 46. User may move the release member 54 backward to disengage the paws 46 with the driving gear 24. The frame 16 is provided with a stop member 56, which is a bolt in the present invention, to stop the release member 54 when the release member 54 is returned by the torsional springs 50. A hook 58 is pivoted on the frame 16 by a pin 60. The hook 58 is behind the release member 54 to be turned within a range. In a normal condition the paws 46 are normally engaged with the driving gear 24 (FIG. 3) that user may only turn the handle 32 in one direction to move the exerting member 22 forward. It may not turn the handle 32 reversely because of the paws 46. Without any extra lock procedure, the exerting member 22 is secured right there when user is no longer turning the handle 32. As shown in FIG. 5, when the release member 54 is moved backward and is hooked by the hook 58, the paws 46 are disengaged with the driving gear 24. Under such condition the handle 32 is free to be turned in both directions to move the exerting member 22 forward and backward. To quite this condition, it only needs to release the hook 58, and then the torsional springs 50 will urge the paws 46 engaging the driving gear 24 again.

As shown in FIG. 2 and FIG. 3, the base 10 is provided with a support member 62 at a rear end, opposite the reverse exerting portion 14. The support member 64 is pivoted on the base 10 by hinges 64 to be turned between an extended position (FIG. 2) and a folded position (FIG. 3). The support member 62 is an L-shaped member having a plate 66 and two legs 68 perpendicular to the plate 66. When the support member 62 is turned to the extended position, the legs 68 are below the base 10 and parallel to the reverse exerting portion 14 (FIG. 2). The present invention further provides two lockers 70 pivoted on the base 10 behind the support member 62. The lockers 70 may be turned to a position above the support member 62 when the support member 62 is turned to the extended position that may secure the support member 62 at the extended position. When turning the lockers 70 away from the support member 62, the support member 62 may be turned upward to rest on the base 10, which is the folded position of the support member 62 (FIG. 3).

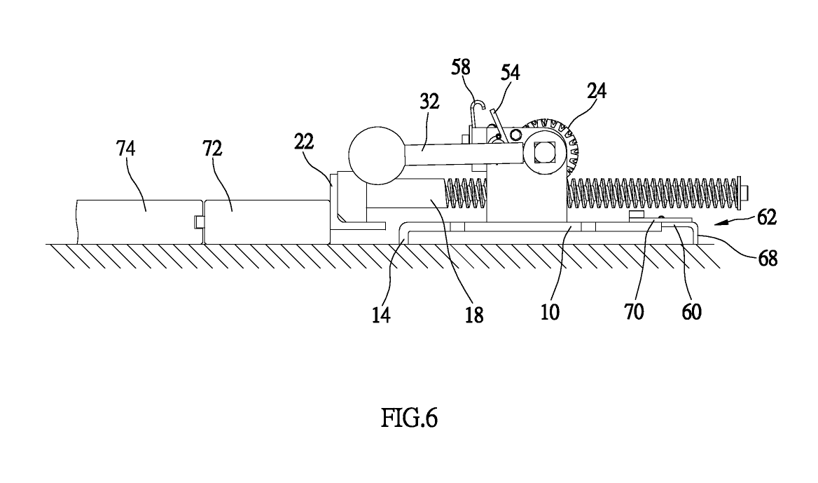

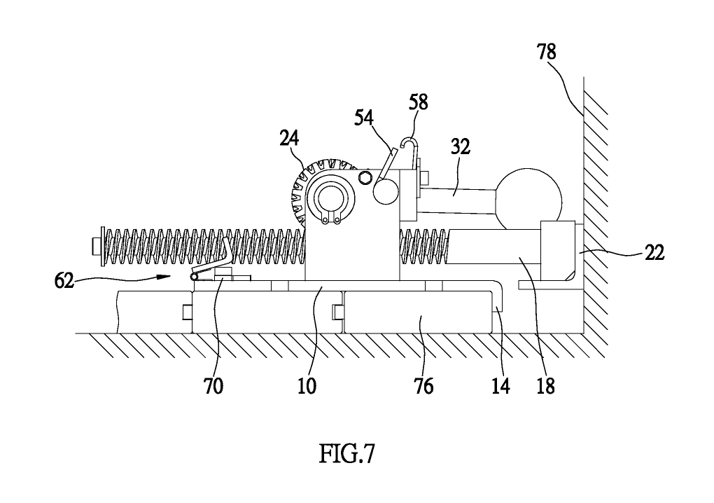

As shown in FIG. 6, in a normal condition, worker turns the support member 62 to the extended position and secures it by the lockers 70, and then puts the floor tile pusher of the present invention in front of a floor tile 72. In this condition, the base 10 has the reverse exerting portion 14 and the legs 68 of the support member 62 standing on the ground. Then, the worker turns the handle 32 to move the exerting member 22 toward the floor tile 72 that the exerting member 34 may press the floor tile 78 to tightly engage a neighboring floor tile 74. As shown in FIG. 7, when floor tiles are close to a wall and there is no sufficient space for the floor tile pusher of the present invention, worker has to release the locker 70 and turn the support member 62 to the folded position, and then put the base 10 on the floor tile 76 with the reverse exerting portion 14 touching an edge of the floor tile 76. Next, worker turns the handle 32 to move the exerting member 22 toward the wall 78. After the exerting member 22 touching the wall 78, worker keeps turning the handle 32 to make the base 10 moving backward that the reverse exerting portion 14 may draw the floor tile 78 backward.

Because the reverse exerting member is a part of the base that it may provide a greater output power before breaking down. The support member acts as a switch to change the floor tile pusher between two working modes.

Although the floor tile pusher of the present invention is designed for tiling tasks, it may be used in any task that requires pressing, moving or lifting different types of boards and other similar objects.

The description above is a few preferred embodiments of the present invention and the equivalence of the present invention is still in the scope of the claim of the present invention.

What is claimed is:

1. A floor tile pusher, comprising:
a base having a frame on a top thereof and a front end bent downward to form a reverse exerting portion;
a bar, which has teeth, provided on the base for reciprocation;
an exerting member connected to an end of the bar;
a driving gear pivoted on the base to be meshed with the teeth of the bar;
an handle connected to the driving member to be operated to turn the driving member; and
a support member, which has a leg, provided on the base to be moved between an extended position, in which a distal end of the leg is substantially even to a distal end of the reverse exerting portion, and a folded portion.

2. The floor tile pusher as defined in claim 1, wherein the support member further has a plate, and the leg is connected to the plate and is substantially perpendicular to the plate.

3. The floor tile pusher as defined in claim 1, further comprising a locker to secure the support member at the extended position.

4. The floor tile pusher as defined in claim 3, wherein the locker has an end pivoted on the base to be turned to a position above the support member when the support member is moved to the extended position.

5. The floor tile pusher as defined in claim 1, further comprising a paw pivoted on the frame and a spring urging the paw toward the driving gear to engage the paw with the driving gear.

6. The floor tile pusher as defined in claim 5, further comprising a release member pivoted on the base, wherein the paw has a lever, and the release member touches the lever to disengage the paw with the driving gear by moving the release member.

7. The floor tile pusher as defined in claim 6, further comprising a stop member on the base, wherein the release member touches the stop member when the paw is engaged with the driving gear.

8. The floor tile pusher as defined in claim 6, further comprising a hook provided on the base to hook the release member when the release member is move to disengage the paw with the driving gear.

9. The floor tile pusher as defined in claim 1, further comprising a shaft passing through the frame and a bore of the driving gear, and then connected to the handle, wherein the shaft has a slot, and the driving gear has a slot on a sidewall of the bore to receive a block in both of the slots.

10. The floor tile pusher as defined in claim 9, further comprising a pin, wherein the driving gear has a bore extending to the slot, and the pin is inserted into the bore to press the block.
